(19) United States
(12) Patent Application Publication
(10) Pub. No.: US 2014/0189043 A1
(43) Pub. Date: Jul. 3, 2014

(54) NETWORK DATA STORAGE SYSTEM, APPARATUS AND METHOD THEREOF

(71) Applicant: Cal-Comp Electronics & Communications Company Limited, (US)

(72) Inventor: Ing-Hui Yang, New Taipei City (TW)

(73) Assignee: Cal-Comp Electronics & Communications Company Limited, New Taipei City (TW)

(21) Appl. No.: 13/789,695

(22) Filed: Mar. 8, 2013

(30) Foreign Application Priority Data
Dec. 27, 2012 (TW) 101150641

(51) Int. Cl. H04L 29/08

(52) U.S. Cl. CPC H04L 67/1097
USPC 709/214

(57) ABSTRACT

A network data storage system is provided. The system includes a data transmitting end, a network data storage apparatus and a notifier. The data transmitting end transmits an external data. The network data storage apparatus is connected to the data transmitting end through an Internet. The notifier is connected to the network data storage apparatus. When the external data is received by the network data storage apparatus, the network data storage apparatus transmits a notification signal to the notifier, and the notifier generates a notification when receiving the notification signal.

### CROSS-REFERENCE TO RELATED APPLICATION

This application claims the priority benefit of Taiwan application serial no. 101150641, filed on Dec. 27, 2012. The entirety of the above-mentioned patent application is hereby incorporated by reference herein and made a part of this specification.

### BACKGROUND OF THE INVENTION

1. Field of the Invention

The invention relates to a network data storage system, apparatus and method thereof.

2. Description of Related Art

Owing to rapid advances in technology in recent years, the use of network attached storage (NAS) has become widespread. Generally speaking, access or setup of a network attached storage apparatus usually requires a user to operate an electronic apparatus such as a personal computer or a mobile device for system parameter setup and for installation, for example, for setup of network address, setup of file format of the network attached storage apparatus or formation of content, setup of user account, and for installation of software in the personal computer corresponding to the network attached storage apparatus, and so on. Only after all of the aforementioned setup is completed, the user is allowed to operate the network attached storage apparatus via the personal computer or other mobile devices.

However, in cases where the user of the network attached storage apparatus is a person with limited competence in computer use or network setup, such as a middle-aged or elderly person unfamiliar with the usage of a personal computer and network-related apparatuses, when required to use or set up the network attached storage apparatus, such user may be unable to operate the network attached storage apparatus or set up the system in a smooth way. Under such circumstances, there is also no effective means in the network attached storage apparatus for informing any change of status of the system of the network attached storage apparatus. For example, when addition or deletion of files occurs in the network attached storage apparatus, there is no effective method of notifying the user of the aforementioned type of the same. Therefore, how to enable the previously described user unfamiliar with operation, setup and usage of a personal computer and network-related apparatuses to use or access a network storage apparatus such as the network attached storage apparatus has become an urgent issue to be solved in this field.

### SUMMARY OF THE INVENTION

The invention provides a network data storage system, apparatus and method thereof, which do not require a personal computer or a mobile device for setup or operation.

The invention provides a network data storage system including a data transmitting end, a network data storage apparatus and a notifier. The data transmitting end transmits an external data. The network data storage apparatus is connected to the data transmitting end through an Internet. The notifier is connected to the network data storage apparatus. When the external data is received by the network data storage apparatus, the network data storage apparatus transmits a notification signal to the notifier, and the notifier generates a notification when receiving the notification signal.

The invention provides a network data storage apparatus including a network unit, a data storage unit and a system management unit. The network unit is connected to an Internet. The data storage unit stores a plurality of data. The system management unit is coupled to the data storage unit, and manages and categorizes the data according to a plurality of key values of each of the data. When an external data is received by the network unit through the Internet, the system management unit stores the external data into the data storage unit as one of the data. In addition, when an external data is received by the network unit through the Internet, the system management unit transmits a notification signal to a notifier to generate a notification.

The invention provides a network data storage method suitable for a network data storage apparatus and including the following steps. First, a plurality of data is stored, and the data is managed and categorized according to a plurality of key values of each of the data. Then, an external data is received through an Internet. When the external data is received, a notification signal is transmitted to a notifier to generate a notification.

Based on the above, the invention provides a network data storage system, apparatus and method thereof, in which the installation and setup of the network data storage apparatus are completed without assistance from a personal computer or a mobile device. Furthermore, files stored in the network data storage apparatus are automatically arranged and categorized, and an effect that a user is notified of an update to the files is achieved.

In order to make the aforementioned features and advantages of the invention more comprehensible, embodiments accompanied with figures are described in detail below.

### BRIEF DESCRIPTION OF THE DRAWINGS

FIG. 1 is a system block diagram of a network data storage system according to an embodiment of the invention.

FIG. 2 is an apparatus block diagram of a network data storage apparatus according to an embodiment of the invention.

FIG. 3 is a method flow diagram of setting up a network data storage apparatus in a network data storage system according to an embodiment of the invention.

FIG. 4 is a timing flow diagram of an account authentication procedure of a network data storage system according to an embodiment of the invention.

FIG. 5 is a system block diagram of a network data storage system according to an embodiment of the invention.

FIG. 6 is a timing flow diagram of a network data storage system according to an embodiment of the invention.

FIG. 7 is a schematic diagram of an appearance of a remote control apparatus according to an embodiment of the invention.

FIG. 8 is a timing flow diagram of a network data storage system setting up a video communication according to an embodiment of the invention.

FIG. 9 is a flow diagram of a network data storage method according to an embodiment of the invention.

### DETAILED DESCRIPTION OF THE EMBODIMENTS

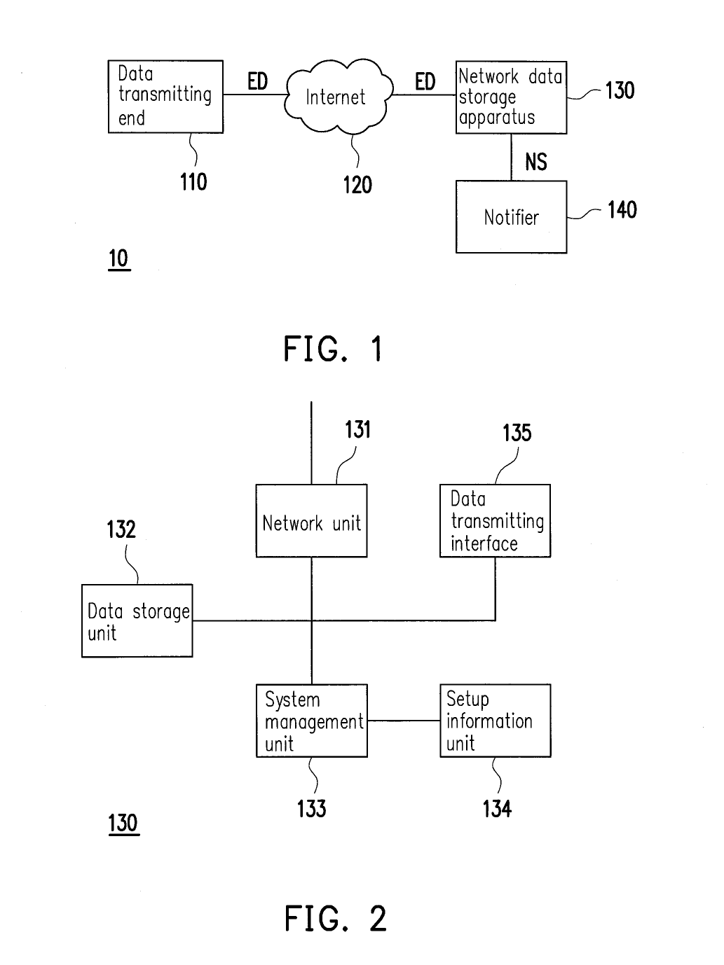

FIG. 1 is a system block diagram of a network data storage system according to an embodiment of the invention. Referring to FIG. 1, a network data storage system 10 includes a data transmitting end 110, a network data storage apparatus 130 and a notifier 140. The data transmitting end 110 transmits an external data ED. The network data storage apparatus 130 is connected to the data transmitting end 110 through an Internet 120. The notifier 140 is connected to the network data storage apparatus 130. When the external data ED is received by the network data storage apparatus 130, the network data storage apparatus 130 transmits a notification signal NS to the notifier 140, and the notifier 140 generates a notification when receiving the notification signal NS.

In the present embodiment, the data transmitting end 110 is any electronic apparatus connected with the network data storage apparatus 130 through the Internet 120, such as a smart phone and a tablet PC. The network data storage apparatus 130 is a network data storage apparatus capable of receiving data through the Internet 120 and of storing the data. The notifier 140 is configured to generate a notification to notify a user that a new arriving external data has been received. For example, the notifier 140 includes elements capable of notifying the user of change of a system status such as a buzzer, a speaker, a vibrator, and a light emitting diode (LED). The notification generated by the notifier 140 may include a generated sound, a generated vibration or a varied light, by which the user is notified. However, the methods of notifying the user are not limited to the above.

FIG. 2 is an apparatus block diagram of a network data storage apparatus according to an embodiment of the invention. Referring to FIG. 2, the network data storage apparatus 130 includes a network unit 131, a data storage unit 132, a system management unit 133, a setup information unit 134 and a data transmitting interface 135. The network unit 131 is connected to the Internet 120 so as to be connected to other apparatuses such as the data transmitting end 110 to receive the external data ED.

The data storage unit 132 is connected to the network unit 131 and stores a plurality of data, wherein the data types include textual document or multimedia such as photo and video, or even a backup file of a storage apparatus, and the invention is not limited thereto. The data storage unit 132 includes physical memory, and is a hard disk drive (HDD), a solid state disk (SSD), a mixed HDD and SSD hard drive, or a redundancy arrays of independent disks (RAID) structure. The invention is not limited to the above.

When storing the aforementioned data, the data storage unit 132 stores not only the data content, but also a plurality of corresponding key values according to the data content of each of the data and states in which the data is transmitted. The key values include file type (textual document, multimedia file, etc.), file creation date (or shooting date of a photo or video, for example), person who uploads the file, position information from the Global Positioning System (GPS), and so on, but are not limited to the above.

The system management unit 133 is coupled to the data storage unit 132 and the network unit 131, and manages and categorizes the data according to the key values of each of the data.

When an external data (e.g. the external data ED transmitted from the data transmitting end 110 in FIG. 1) is received by the network unit 131 through the Internet 120, the system management unit 133 stores the external data into the data storage unit 132 as one of the aforementioned data, and at the same time, stores the key value corresponding to the data.

The setup information unit 134 is coupled to the system management unit 133, wherein the system management unit 133 is also configured to operate an embedded operating system of the network data storage apparatus 130. Meanwhile, the system management unit 133 also manages an administrator account and a plurality of user accounts of the embedded operating system, and stores a plurality of account information corresponding to the administrator account and the user accounts into the setup information unit 134. The account information includes user account, password, and recovered password, but is not limited thereto. The account information may also include information for assisting in system management, such as number of times of log-in of an account, log-in time and files accessed.

The system management unit 133 is achieved by a processor for general purposes or a system-on-a-chip (SoC) in combination with a memory with an appropriate size and access speed, or by using an application-specific integrated circuit (ASIC). The invention is not limited to the above.

The data transmitting interface 135 is coupled to the data storage unit 132 and the system management unit 133. When the data transmitting interface 135 is connected to an external storage apparatus, an external data is received by the system management unit 133 from the external storage apparatus through the data transmitting interface 135. The external data is viewed by the system management unit 133 as one of the data, and is stored into the data storage unit 132.

In the present embodiment, the external storage apparatus is a mobile storage apparatus connected via a universal serial bus (USB), such as a USB flash drive and an external hard drive, or a memory card such as a secure digital (SD) card, a micro SD card, a multi media card (MMC), a compact flash (CF) card, and a memory stick. The data transmitting interface 135 includes a connecting interface corresponding to the aforementioned mobile storage apparatuses and memory cards, such as a USB port and a slot corresponding to the aforementioned memory cards of various formats, and is installed depending on actual needs.

It is noticed that the data transmitted through the data transmitting interface 135 and stored into the data storage unit 132 includes the key values transmitted correspondingly to the data transmitting interface 135 or the key values corresponding to the user currently logging in the embedded operating system when transmitted through the data transmitting interface 135. The above is adjusted depending on conditions of actual practice.

In the present embodiment, the network data storage apparatus 130 operates, one of the created user accounts is required for an external electronic apparatus, such as the data transmitting end 110 shown in FIG. 1, to log in the embedded operating system of the network data storage apparatus 130 before transmitting the external data to the network data storage apparatus 130. Regarding operating manners associated with the administrator account and the user accounts, an explanation will be given below by referring to additional embodiments and drawings.

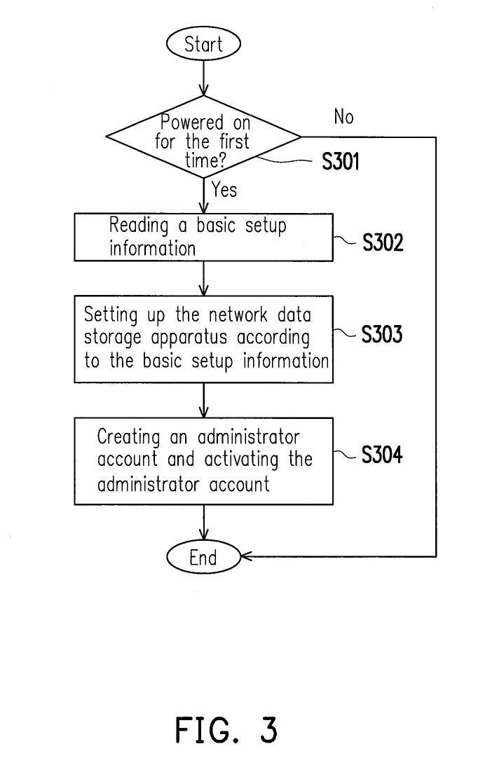

FIG. 3 is a method flow diagram of setting up a network data storage apparatus in a network data storage system according to an embodiment of the invention. Referring to FIG. 2 and FIG. 3, when the network data storage apparatus 130 is powered on (i.e. the power is turned on), the system management unit 133 first determines if this power-on is a first-time power-on (step S301). If the network data storage apparatus 130 is not powered on for the first time, the following setup process will be unnecessary, and the procedure will be ended and the network data storage apparatus 130 is ready for use.

When the network data storage apparatus 130 is powered on for the first time, the system management unit 133 reads a basic setup information from the setup information unit 134 (step S302). The basic setup information includes general network setup information or default file formats of the data storage unit 132 and so on, but is not limited thereto. Next, the network data storage apparatus 130 sets up the network data storage apparatus 130 according to the basic setup information (step S303). The setup content is, for example, setup of network environment of the network unit 131, formatting of the data storage unit 132, setup of file format, setup of space partition, and so on. The setup is performed by use of the basic setup information stored in the setup information unit 134, and there is no need for the user to set up each parameter one by one manually.

Next, after completing the setup of the network data storage apparatus 130, the system management unit 133 creates and activates the administrator account (step S304). The administrator account is has the top-level permission for the embedded operating system for advanced management of the network data storage apparatus 130, such as account management, data movement, data deletion or other system management functions.

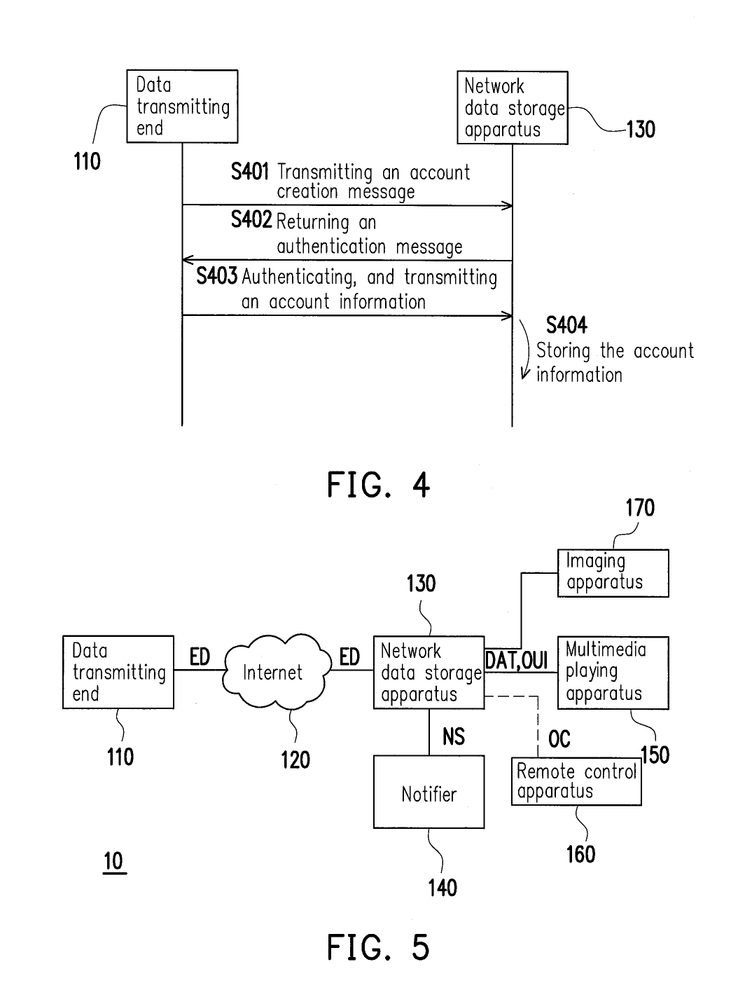

User accounts other than the administrator account, after being created, are ready for use only after an account authentication procedure. FIG. 4 is a timing flow diagram of an account authentication procedure of a network data storage system according to an embodiment of the invention. In the present embodiment, the user of the data transmitting end 110 intends to apply for an account of the embedded operating system of the network data storage apparatus 130 by using the data transmitting end 110.

Referring to FIG. 4, first, the data transmitting end 110 transmits an account creation message to the network data storage apparatus 130 (step S401). When the account creation message is received by the network data storage apparatus 130, the network data storage apparatus 130 returns an authentication message to the data transmitting end 110. Next, the data transmitting end 110 performs an authentication according to the authentication message, and transmits the account information to the network data storage apparatus 130 (step S403). After receiving the account information, the network data storage apparatus 130 stores the account information into the setup information unit 134. The user account includes information such as user name and log-in password.

There are different practices in the step of authentication according to actual circumstances. For example, the data transmitting end 110 may return an authentication code at the same time of returning the account information according to the content of the authentication message. Or, the network data storage apparatus 130 may attach to the authentication message a one-time authentication web address to the network data storage apparatus 130. When the user of the data transmitting end 110 clicks the aforementioned authentication web address and is directed back to the network data storage apparatus 130, the authentication procedure is completed, and the one-time authentication web address expires after completion of the procedure. The authentication method is merely one embodiment for explaining the way of authentication, and the invention is not limited to the aforementioned authentication method.

In addition, the embodiment shown in FIG. 4 is also merely an example of the account authentication procedure. Furthermore, there may be other alteration in the account authentication procedure according to conditions of practice. For example, a two-dimensional bar code such as a QR code is utilized as a replacement for the aforementioned authentication web address transmitted via the authentication message, or the data transmitting end 110 and the network data storage apparatus 130 are paired together by near field communication (NFC) to complete the account authentication procedure. The invention is not limited to the aforementioned embodiments.

FIG. 5 is a system block diagram of a network data storage system according to an embodiment of the invention. Referring to FIG. 5, compared to the embodiment shown in FIG. 1, in the embodiment shown in FIG. 5, the network data storage system 10 further includes a multimedia playing apparatus 150, a remote control apparatus 160 and an imaging apparatus 170.

The multimedia playing apparatus 150 is connected to the network data storage apparatus 130. When the network data storage apparatus 130 transmits a data DAT to the multimedia playing apparatus 150, the multimedia playing apparatus 150 is configured to display/play the data DAT. The network data storage apparatus 130 also controls the multimedia playing apparatus 150 to display an operating interface OUI of the embedded operating system of the network data storage apparatus 130.

The multimedia playing apparatus 150 is connected to the network data storage apparatus 130 in a plurality of manners. For example, image-related content in the data is transmitted in wired manners such as through an RGB connector, a component video connector and a D-Sub connector, or image and sound contents are transmitted at the same time through a high definition multimedia interface (HDMI) connection. In addition, the multimedia playing apparatus 150 may be disposed in the network data storage apparatus 130, but is not limited thereto. The invention covers all combinations that provide a multimedia playing function.

In addition, the multimedia playing apparatus 150 and the network data storage apparatus 130 may also be connected via a cable network (e.g. Ethernet) or a wireless network (e.g. wireless local area network (WLAN) in compliance with the standard of wireless fidelity (WiFi)), and the data DAT is transmitted from the network data storage apparatus 130 to the multimedia playing apparatus 150 through a general network packet transmission method, or a digital living network alliance (DLNA) or wireless display (WiDi) transmission method, and the invention is not limited to the aforementioned embodiments.

The remote control apparatus 160 is connected to the network data storage apparatus 130 in a wireless manner, and transmits a control command OC to the network data storage apparatus 130 through the user's operation. When the control command OC is received by the network data storage apparatus 130, the network data storage apparatus 130 displays a data list on the operating interface OUI according to the control command OC, or transmits one of the data DAT to the multimedia playing apparatus 150 to play the data DAT. The aforementioned wireless manner is a conventional infrared transmission technique, or a short-distance wireless transmission method in compliance with the Bluetooth or Zigbee standard, etc. The invention is not limited to the aforementioned embodiments.

It is noticed that the notifier 140 may be disposed independently, or may be disposed in the network data storage apparatus 130 and/or the remote control apparatus 160 so as to enable the user to detect the generation of the notification more easily. On the other hand, in an embodiment of the invention, when the network data storage apparatus 130 generates the notification signal NS and transmits the same to the notifier 140, the network data storage apparatus 130 also generates a notification icon and transmits the same to the multimedia playing apparatus 150 so as to display the notification icon on the operating interface OUI. However, the invention is not limited to the aforementioned embodiments and installation, and is adjusted depending on conditions of actual practice.

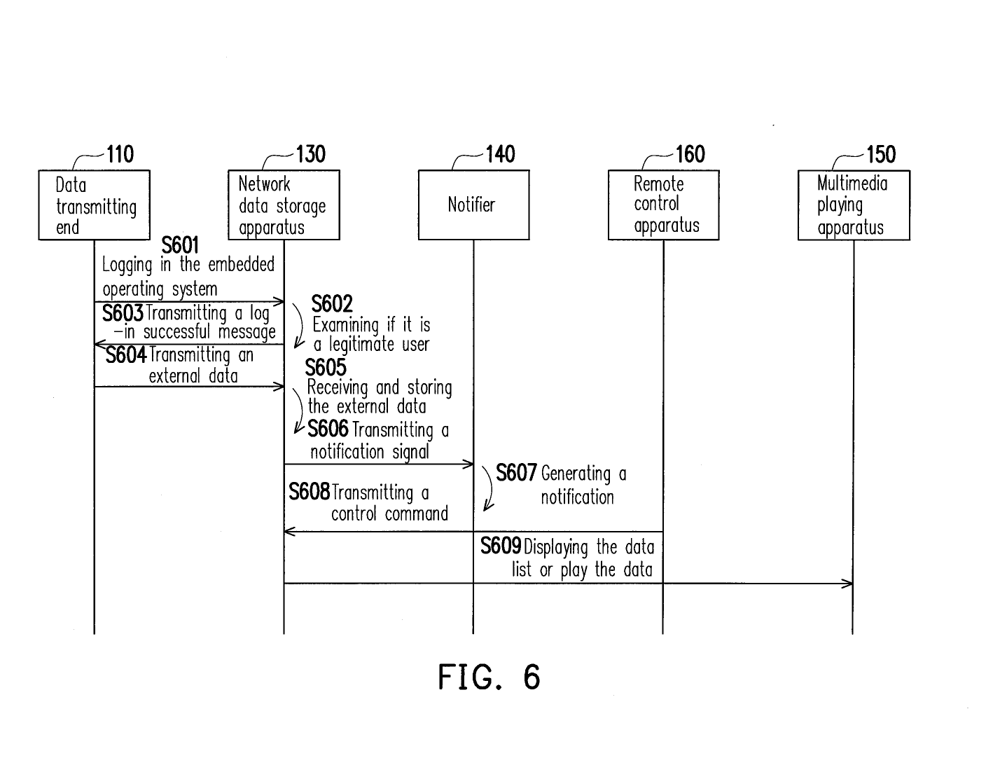

FIG. 6 is a timing flow diagram of a network data storage system according to an embodiment of the invention. Referring to FIG. 6, before the data transmitting end 110 transmits a data to the network data storage apparatus 130, the data transmitting end 110 first has to log in the embedded operating system of the network data storage apparatus 130 by using an authenticated user account (step S601). When the log-in of the data transmitting end 110 is received by the network data storage apparatus 130, the network data storage apparatus 130 examines if the user account is a legitimate user, i.e. an authenticated user account (step S602). If the network data storage apparatus 130 detects that the user account of the data transmitting end 110 is a legitimate user, the network data storage apparatus 130 returns a log-in successful message to the data transmitting end 110 (step S603).

Still referring to FIG. 6, after the data transmitting end 110 successfully logs in the embedded operating system of the network data storage apparatus 130, the data transmitting end 110 transmits an external data to the network data storage apparatus 130 (step S604). When the external data is received by the network data storage apparatus 130, the network data storage apparatus 130 stores the external data as one of the data. The network data storage apparatus 130 also stores corresponding key values according to the file type and creation date/shooting date of the external data as well as the user account of the data transmitting end 110 (step S605).

Meanwhile, the network data storage apparatus 130 further transmits a notification signal to the notifier 140 (step S606) to cause the notifier 140 to generate a notification (step S607). Accordingly, the user is informed by the notification from the notifier 140 that a data has newly arrived at the network data storage apparatus 130. To read/view the new arriving data, the user may transmit a control command to the network data storage apparatus 130 by using the remote control apparatus 160 (e.g. by pressing a press key on the remote control apparatus 130 (step S608).

When the control command is received by the network data storage apparatus 130, the network data storage apparatus 130 transmits the new arriving data to the multimedia playing apparatus 150 to display/play the data. When the number of the external data transmitted from the data transmitting end 110 is more than one, or when a plurality of the external data are transmitted to the network data storage apparatus 130 at the same time from a plurality of electronic apparatuses as the data transmitting end 110 by using different user accounts, the network data storage apparatus 130 transmits a data list of the plurality of data to the multimedia playing apparatus 150 so as to display the data list of the plurality of data on the operating interface (step S509).

On the other hand, the user also selects the data content to display/play or the data list to view by transmitting the control command. For example, the user controls the remote control apparatus 160 to transmit the control command including one of the key values. When the control command is received by the network data storage apparatus 130, the network data storage apparatus 130 performs a management to obtain a data list according to the key value of the control command, wherein the data in the data list all includes the key value. Next, the network data storage apparatus 130 transmits the data list to the multimedia playing apparatus 150 so as to display the data list on the operating interface.

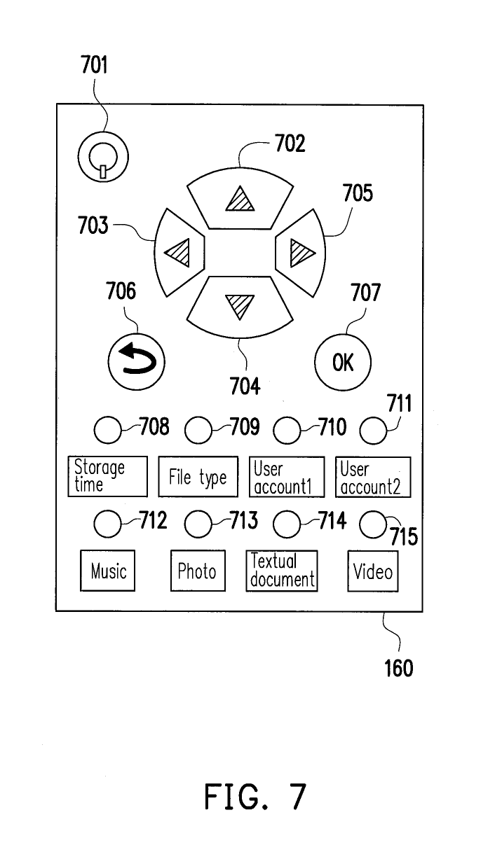

How the user controls the remote control apparatus 160 to transmit the control command including the key value is described hereinafter by referring to an embodiment of the remote control apparatus 160. FIG. 7 is a schematic diagram of an appearance of a remote control apparatus according to an embodiment of the invention. Referring to FIG. 7, there is a plurality of physical press keys on the remote control apparatus 160, such as a power key 701, direction keys 702-705, a back key 706, a confirmation key 707 and function keys 708-715. The power key 701 is configured to control a power switch of the network data storage apparatus 130. The direction keys 702-705 are configured to operate a cursor on the operating interface. When the cursor moves over the data on the data list which is to be played, the user clicks the confirmation key 707 to confirm a playing, or clicks the back key 706 to go back to its parent directory. Since persons of ordinary skill in the art may utilize the prior art to transmit the control command from the remote control apparatus 160 for controlling the cursor on the operating interface and for performing confirmation/back actions, details thereof are omitted herein.

The function keys 708-715 correspond respectively to different key values, such as data storage time, file type, data uploaded by a user account 1, and data, music, photos, textual documents and videos uploaded by a user account 2, and so on. When the user presses one of the function keys 708-715 (an operating signal corresponding to one of the function keys 708-715 is received by the remote control apparatus), the remote control apparatus 160 transmits a control command including the key value corresponding to one of the function keys 708-715 to the network data storage apparatus 130.

By means of the aforementioned setup, the user may view the desired content in a relaxed way simply by pressing one of the function keys. For example, the user account 1 and the user account 2 correspond respectively to accounts of the user's son and the user's daughter. By pressing the function key 710, the user controls the multimedia playing apparatus 150 to display a photo or a video uploaded by the user's son.

The network data storage apparatus 130 transmits the data list of the data corresponding to the key value to the multimedia playing apparatus 150 to display the data list. It is possible that the data list is rearranged by using other key values so that a fixed amount of the data is displayed. For example, when the user clicks the function key 710 to cause the operating interface to display the data list uploaded by the user account 1, the network data storage apparatus 130 only transmits a data list of twenty pieces of data recently transmitted by the user account 1 to the multimedia playing apparatus 150. However, the invention is not limited to the aforementioned embodiments.

It is noticed that the function keys 708-715 in the present embodiment and their corresponding key values are only for exemplary purposes, and the invention does not limit the number of the function keys or the key values corresponding to the function keys (e.g. the function keys 708-715). For example, in an embodiment of the invention, the key values corresponding to each of the function keys are set up through the administrator account. In addition, a plurality of the key values is organized as a key value list to be displayed on the operating interface of the network data storage apparatus 130 for the user to utilize the direction keys 702-705 in combination with the confirmation key 707. On the other hand, the remote control apparatus 160 is not limited to the embodiment shown in FIG. 7, and may be achieved by a touch screen in combination with a user interface, or may be integrated with other electronic apparatus in the prior art, such as with a smart phone or a tablet PC.

Though the main function of the network data storage apparatus 130 lies in file storage and management, as the embedded operating system thereof is capable of processing other applications, in the embodiments of the invention, it may achieve diverse applications by being connected to other external apparatuses. Referring to FIG. 5, the imaging apparatus 170 is connected to the network data storage apparatus 130, and the network data storage apparatus 130 creates a connection for performing a video communication with a remote electronic apparatus (e.g. the data transmitting end 110) through the Internet 120 by using the imaging apparatus 170 and the multimedia playing apparatus 150.

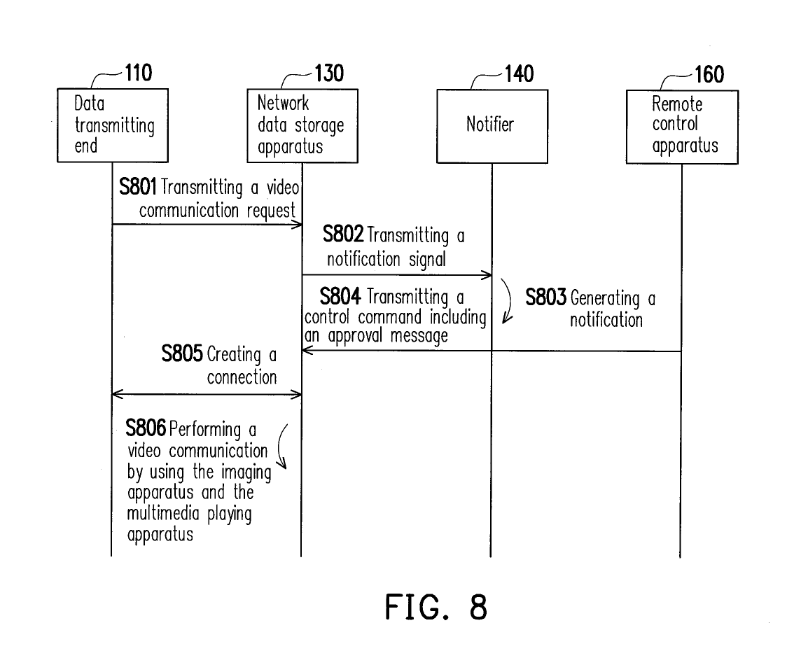

FIG. 8 is a timing flow diagram of a network data storage system setting up a video communication according to an embodiment of the invention. Referring to FIG. 8, after successfully logging in the embedded operating system of the network data storage apparatus 130 by utilizing a user account, the data transmitting end 110 transmits a video communication request to the network data storage apparatus 130 (step S801). After receiving the video communication request, the network data storage apparatus 130 transmits a notification signal to the notifier 140 (step S802) to cause the notifier 140 to generate a notification (step S803). In another embodiment of the invention, the network data storage apparatus 130 also transmits a video communication icon to the multimedia playing apparatus 150 to display the video communication icon on the operating interface.

When the user perceives the notification (or sees the video communication icon on the operating interface) and intends to have a video communication with the user of the data transmitting end 110, the user operates the remote control apparatus 160 to transmit a control command including an approval message to the network data storage apparatus 130 (step S804). When the control command including the approval message is received by the network data storage apparatus 130, the network data storage apparatus 130 creates a connection with the data transmitting end 110 (step S805), and after creating the connection, performs a video communication with the data transmitting end 110 by using the imaging apparatus 170 (for capturing the user's image and voice to be transmitted to the network data storage apparatus 130) and the multimedia playing apparatus 150 (for playing the video content transmitted by the data transmitting end 110).

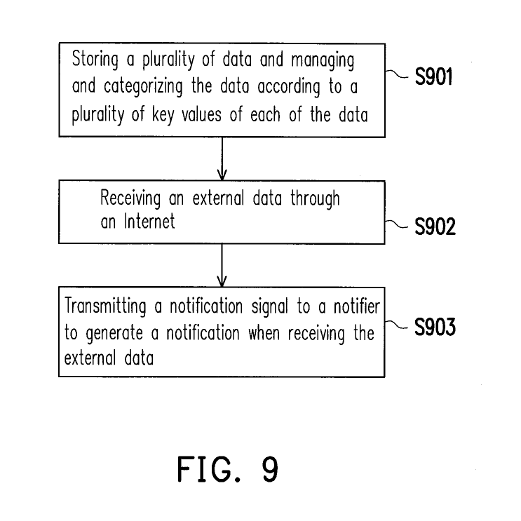

The invention also provides a network data storage method suitable for a network data storage apparatus. FIG. 9 is a flow diagram of a network data storage method according to an embodiment of the invention. Referring to FIG. 9, first, in step S901, a plurality of data is stored, and is managed and categorized according to a plurality of key values of each of the data. Then, in step S902, an external data is received through an Internet. Next, in step S903, i.e. when the external data is received, a notification signal is transmitted to a notifier to generate a notification. Practice details of the method are provided with reference to the embodiments shown in the above FIG. 1 to FIG. 8, and are not repeated herein.

In summary, the invention provides a network data storage system, apparatus and method thereof, enabling a user without any network-related knowledge to use the network data storage apparatus easily. In the network data storage system provided by the invention, the network data storage apparatus sets up itself in a state ready for use, and notifies the user when receiving a new data so that the user is able to view the newest photo, video and other data in real time.

For example, an elderly person is using the network data storage apparatus provided by the invention at home, and his or her child may transmit multimedia data, such as a photo or a video shot at a remote place, to the network data storage apparatus by using a pre-authenticated user account. After receiving such new arriving data, the network data storage apparatus generates a light or sound to notify the elderly person. When the elderly person detecting the change of the notifier, he or she may operate the remote control apparatus to remotely control the network data storage apparatus to view the photo or video transmitted from the child. In addition, the elderly person is also able to view each of the data in the network data storage apparatus by using the remote control apparatus in combination with the operating interface of the network data storage apparatus.

Though the invention has been disclosed above by the embodiment, it is not intended to limit the present invention. It will be apparent to persons of ordinary skill in the art that modifications and variations to the described embodiments may be made without departing from the spirit and scope of the present invention. Therefore, the protecting range of the invention falls in the appended claims.

What is claimed is:

1. A network data storage system, comprising:
a data transmitting end transmitting and receiving an external data through an Internet;
a network data storage apparatus connected to the data transmitting end through the Internet; and
a notifier connected to the network data storage apparatus;
wherein when the external data is received by the network data storage apparatus, the network data storage apparatus transmits a notification signal to the notifier, and the notifier generates a notification when receiving the notification signal.

2. The network data storage system as claimed in claim 1, wherein the network data storage apparatus comprises:
a network unit connected to the Internet;
a data storage unit connected to the network unit, storing a plurality of data; and
a system management unit coupled to the data storage unit, managing and categorizing the data according to a plurality of key values of each of the data,
wherein when the external data is received by the network unit through the Internet, the system management unit stores the external data into the data storage unit as one of the data.

3. The network data storage system as claimed in claim 2, wherein
the network data storage apparatus further comprises a data transmitting interface coupled to the data storage unit and the system management unit, and when the data transmitting interface is connected to an external storage apparatus, the external data is received by the network data storage apparatus from the external storage apparatus through the data transmitting interface.

4. The network data storage system as claimed in claim 2, wherein the network data storage apparatus further comprises:
a setup information unit coupled to the system management unit, wherein
the system management unit further operates an embedded operating system to manage an administrator account and a plurality of user accounts of the embedded operating system, and to store a plurality of account information corresponding to the administrator account and the user accounts into the setup information unit; and
the data transmitting end further logs in the embedded operating system by using one of the user accounts before transmitting the external data to the network data storage apparatus.

5. The network data storage system as claimed in claim 4, wherein
when the network data storage apparatus is turned on for the first time, the system management unit reads a basic setup information from the setup information unit and sets up the network data storage apparatus according to the basic setup information; and
the system management unit creates the administrator account and activates the administrator account after setting up the network data storage apparatus according to the basic setup information.

6. The network data storage system as claimed in claim 4, wherein
the data transmitting end further completes an account authentication procedure before further logging in the embedded operating system by using one of the user accounts, wherein the account authentication procedure comprises:
the data transmitting end transmitting an account creation message to the network data storage apparatus;
the system management unit of the network data storage apparatus returning an authentication message to the data transmitting end through the network unit according to the account creation message; and
the data transmitting end returning the account information to the network data storage apparatus according to the authentication message.

7. The network data storage system as claimed in claim 6, wherein
the key values of each of the data comprise the account information corresponding to one of the accounts.

8. The network data storage system as claimed in claim 4, wherein the network data storage system further comprises:
a multimedia playing apparatus connected to the network data storage apparatus, the network data storage apparatus controlling the multimedia playing apparatus to display an operating interface of the embedded operating system of the network data storage apparatus; and
a remote control apparatus connected to the network data storage apparatus in a wireless manner, transmitting a control command to the network data storage apparatus,
wherein when the control command is received by the network data storage apparatus, the network data storage apparatus displays a data list on the operating interface or transmits one of the data to the multimedia playing apparatus to play the data according to the control command.

9. The network data storage system as claimed in claim 8, wherein
the multimedia playing apparatus is disposed on the network data storage apparatus.

10. The network data storage system as claimed in claim 8, wherein
the remote control apparatus comprises a plurality of press keys, wherein the press keys correspond respectively to the key values;
when an operating signal corresponding to one of the press keys is received by the remote control apparatus, the remote control apparatus transmits the control command to the network data storage apparatus, wherein the control command comprises the key value corresponding to one of the press keys; and
when the control command comprising the key value is received by the network data storage apparatus, the network data storage apparatus transmits the data list to the multimedia playing apparatus to display the data list on the operating interface, wherein the data list comprises the data having the key value.

11. The network data storage system as claimed in claim 8, wherein the network data storage system further comprises:
an imaging apparatus connected to the network data storage apparatus,
wherein when the data transmitting end transmits a video communication request to the network data storage apparatus, the network data storage apparatus transmits the notification signal to the notifier to generate the notification;
the remote control apparatus transmitting the control command comprising an approval message to the network data storage apparatus;
when the control command is received by the network data storage apparatus, the network data storage apparatus transmitting a return message to the data transmitting end to create a connection; and
after creating the connection, the network data storage apparatus performing a video communication with the data transmitting end by using the multimedia playing apparatus and the imaging apparatus.

12. The network data storage system as claimed in claim 8, wherein
the notifier is disposed on the network data storage apparatus or the remote control apparatus.

13. The network data storage system as claimed in claim 8, wherein
the notifier comprises a first sub-notification unit and a second sub-notification unit, wherein the first sub-notification unit is disposed on the network data storage apparatus, and the second sub-notification unit is disposed on the remote control apparatus.

14. A network data storage apparatus, comprising:
a network unit connected to an Internet;
a data storage unit storing a plurality of data; and
a system management unit coupled to the data storage unit, managing and categorizing the data according to a plurality of key values of each of the data,
wherein when an external data is received by the network unit through the Internet, the system management unit stores the external data into the data storage unit as one of the data; and
wherein when an external data is received by the network unit through the Internet, the system management unit transmits a notification signal to a notifier to generate a notification.

15. The network data storage apparatus as claimed in claim 14, wherein the network data storage apparatus further comprises:
a data transmitting interface coupled to the data storage unit and the system management unit, wherein when the data transmitting interface is connected to an external storage apparatus, the external data is received by the system management unit from the external storage apparatus through the data transmitting interface and is stored into the data storage unit.

16. The network data storage apparatus as claimed in claim 14, wherein the network data storage apparatus further comprises:
a setup information unit coupled to the system management unit, wherein
the system management unit further operates an embedded operating system to manage an administrator account and a plurality of user accounts of the embedded operating system, and to store a plurality of account information corresponding to the administrator account and the user accounts into the setup information unit; and
a data transmitting end logging in the embedded operating system by using one of the user accounts and transmitting the external data to the network unit.

17. The network data storage apparatus as claimed in claim 14, wherein
when the network data storage apparatus is turned on for the first time, the system management unit reads a basic setup information from the setup information unit and sets up the network data storage apparatus according to the basic setup information; and
the system management unit creates the administrator account and activates the administrator account after setting up the network data storage apparatus according to the basic setup information.

18. The network data storage apparatus as claimed in claim 14, wherein
when an account creation message is received by the system management unit through the network unit, the system management unit returns an authentication message through the network unit according to the account creation message; and
when an account information returned according to the authentication message is received by the system management unit, the system management unit creates a user account according to the account information and stores the user account and the account information into the setup information unit.

19. The network data storage apparatus as claimed in claim 14, wherein
the key values of each of the data comprise the account information corresponding to one of the accounts.

20. The network data storage apparatus as claimed in claim 14, wherein
when a control command is received by the system management unit in a wireless manner, the system management unit transmits a data list to a multimedia playing apparatus according to the control command to display the data list, or the system management unit transmits one of the data to the multimedia playing apparatus according to the control command to play the data.

21. The network data storage apparatus as claimed in claim 20, wherein
when the control command comprising one of the key values is received by the system management unit, the system management unit transmits the data list to the multimedia playing apparatus to display the data list, wherein the data list comprises the data having the key value.

22. The network data storage apparatus as claimed in claim 14, wherein
when a video communication request is received by the system management unit from the data transmitting end, the system management unit transmits the notification signal to the notifier to generate the notification;
when a control command comprising an approval message is received by the system management unit in a wireless manner, the system management unit returns a return message to the data transmitting end according to the video communication request to create a connection with the data transmitting end; and
after creating the connection, the system management unit performs a video communication with the data transmitting end by using an external multimedia playing apparatus and an imaging apparatus.

23. The network data storage apparatus as claimed in claim 14, wherein the network data storage apparatus further comprises:
a multimedia playing unit coupled to the system management unit,
wherein when a control command is received by the system management unit in a wireless manner, the system management unit transmits a data list to the multimedia playing unit according to the control command to display the data list, or the system management unit transmits one of the data to the multimedia playing unit according to the control command to play the data.

24. The network data storage apparatus as claimed in claim 23, wherein
when the control command comprising one of the key values is received by the system management unit, the system management unit transmits the data list to the multimedia playing unit to display the data list, wherein the data list comprises the data having the key value.

25. The network data storage apparatus as claimed in claim 23, wherein
when a video communication request is received by the system management unit from the data transmitting end, the system management unit transmits the notification signal to the notifier to generate the notification;
when a control command comprising an approval message is received by the system management unit in a wireless manner, the system management unit returns a return message to the data transmitting end according to the video communication request to create a connection with the data transmitting end; and
after creating the connection, the system management unit performs a video communication with the data transmitting end by using the multimedia playing unit and an external imaging apparatus.

26. The network data storage apparatus as claimed in claim 14, wherein
the notifier is disposed on the network data storage apparatus.

27. A network data storage method suitable for a network data storage apparatus, comprising:
storing a plurality of data, and managing and categorizing the data according to a plurality of key values of each of the data;
receiving an external data through an Internet; and
transmitting a notification signal to a notifier when receiving the external data, to generate a notification.

28. The network data storage method as claimed in claim 27, wherein the step of storing the data further comprises:
receiving the external data from an external storage apparatus through a data transmitting interface when the data transmitting interface is connected to the external storage apparatus, and storing the external data as one of the data.

29. The network data storage method as claimed in claim 27, wherein before the step of receiving the external data, further comprising:
operating an embedded operating system;
managing an administrator account and a plurality of user accounts of the embedded operating system;
storing a plurality of account information corresponding to the administrator account and the user accounts; and
allowing a data transmitting end to log in the embedded operating system by using one of the user accounts.

30. The network data storage method as claimed in claim 29, wherein before the step of allowing the data transmitting end to log in by using the user account, further comprising:
determining whether the network data storage apparatus is turned on for the first time, and if the network data storage apparatus is turned on for the first time, reading a basic setup information and setting up the network data storage apparatus according to the basic setup information; and
creating an administrator account and activating the administrator account after setting up the network data storage apparatus according to the basic setup information.

31. The network data storage method as claimed in claim 29, wherein before the step of allowing the data transmitting end to log in by using the user account, further comprising:
receiving an account creation message;
returning an authentication message according to the account creation message; and
when receiving an account information returned according to the authentication message, creating a user account according to the account information and storing the user account and the account information.

32. The network data storage method as claimed in claim 31, wherein
the key values of each of the data comprise the account information corresponding to one of the accounts.

33. The network data storage method as claimed in claim 27, wherein the network data storage method further comprises:
receiving a control command in a wireless manner;
transmitting a data list to a multimedia playing apparatus according to the control command to display the data list, or transmitting one of the data to the multimedia playing apparatus according to the control command to play the data.

34. The network data storage method as claimed in claim 33, wherein the network data storage method further comprises:
when receiving the control command comprising one of the key values, transmitting the data list to the multimedia playing apparatus to display the data list, wherein the data list comprises the data having the key value.

35. The network data storage method as claimed in claim 29, wherein the network data storage method further comprises:
when receiving a video communication request, transmitting the notification signal to the notifier to generate the notification;
when receiving the control command comprising an approval message in a wireless manner, returning a return message to the data transmitting end according to the video communication request to create a connection with the data transmitting end; and
after creating the connection, performing a video communication with the data transmitting end by using a multimedia playing apparatus and an imaging apparatus.

36. The network data storage method as claimed in claim 27, wherein the network data storage method further comprises:
receiving a control command in a wireless manner;
transmitting a data list to a multimedia playing unit of the network data storage apparatus according to the control command to display the data list, or transmitting one of the data to the multimedia playing unit according to the control command to play the data.

37. The network data storage method as claimed in claim 33, wherein the network data storage method further comprises:
when receiving the control command comprising one of the key values, transmitting the data list to the multimedia playing unit to display the data list, wherein the data list comprises the data having the key value.

38. The network data storage method as claimed in claim 29, wherein the network data storage method further comprises:
when receiving a video communication request, transmitting the notification signal to the notifier to generate the notification;
when receiving the control command comprising an approval message in a wireless manner, returning a return message to the data transmitting end according to the video communication request to create a connection with the data transmitting end; and
after creating the connection, performing a video communication with the data transmitting end by using a multimedia playing unit and an imaging apparatus.
